(19) United States
(12) Patent Application Publication
(10) Pub. No.: US 2019/0370798 A1
(43) Pub. Date: Dec. 5, 2019

(54) BLOCKCHAIN ASSET ISSUING AND REDEMPTION METHODS AND APPARATUSES, AND ELECTRONIC DEVICE THEREFORE

(71) Applicant: Alibaba Group Holding Limited, George Town (KY)

(72) Inventors: Danqing Hu, Hangzhou (CN); Sen Lin, Shanghai (CN); Junliang ZHANG, Hangzhou (CN)

(73) Assignee: Alibaba Group Holding Limited, George Town (KY)

(21) Appl. No.: 16/425,381

(22) Filed: May 29, 2019

(30) Foreign Application Priority Data
May 29, 2018 (CN) 201810534318.6

(51) Int. Cl. G06Q 20/38; G06F 16/27; G06Q 40/04

(52) U.S. Cl. CPC G06Q 20/389; G06K 19/0723; G06Q 40/04; G06F 16/27

(57) ABSTRACT

A computer-implemented method for supporting a blockchain asset issued on a blockchain, the computer-implemented method including: determining, by a blockchain anchor, that an off-chain asset of a particular amount is in a frozen state; issuing, by the blockchain anchor, the blockchain asset on the blockchain, wherein an amount of the blockchain asset is within the particular amount; and publishing, by the blockchain anchor, a transaction record of the blockchain asset in a blockchain ledger of the blockchain, the transaction record containing a freeze certificate for the blockchain asset showing that the blockchain asset is supported by the off-chain asset that has been determined to be in the frozen state.

### CROSS-REFERENCE TO RELATED APPLICATIONS

This application claims priority to Chinese Patent Application No. 201810534318.6, filed on May 29, 2018, which is hereby incorporated by reference in its entirety.

### TECHNICAL FIELD

One or more implementations of the present specification relate to the terminal device technology field, and in particular, to blockchain asset issuing and redemption methods and apparatuses, and an electronic device therefore.

### BACKGROUND

A blockchain can include several blockchain nodes that can include a blockchain member (simply referred to as a member) and an anchor. The anchor is configured to anchor an off-chain asset and a blockchain asset, and can publish off-chain asset as blockchain assets to implement efficient and reliable on-chain asset transfers, etc. by using a blockchain, or can convert blockchain assets to off-chain assets to implement offline asset transfers, etc.

### SUMMARY

In view of the above, one or more implementations of the present specification provide blockchain asset issuing and redemption methods and apparatuses, and an electronic device therefore.

To achieve the previous objective, one or more implementations of the present specification provide the following technical solutions.

According to a first aspect of one or more implementations of the present specification, a blockchain asset issuing method is proposed, including the following: determining, by a blockchain anchor, that an off-chain asset of a specified amount is in a frozen state; and issuing, by the blockchain anchor, a blockchain asset on a blockchain, where an amount of the blockchain asset is not greater than the specified amount, and a transaction record of the blockchain asset in a blockchain ledger contains a freeze certificate for the off-chain asset.

According to a second aspect of one or more implementations of the present specification, a blockchain asset redemption method is proposed, including the following: receiving, by a blockchain anchor, a redemption request for a blockchain asset initiated by a blockchain member; determining, by the blockchain anchor, whether there is a freeze certificate that corresponds to the blockchain asset based on ledger data in a blockchain ledger; and converting, by the blockchain anchor, the blockchain asset to an off-chain asset of a corresponding amount when there is a freeze certificate that corresponds to the blockchain asset, to provide the off-chain asset to the blockchain member.

According to a third aspect of one or more implementations of the present specification, a blockchain asset issuing apparatus is proposed, including the following: a determining unit, configured to determine, by a blockchain anchor, that an off-chain asset of a specified amount is in a frozen state; and an issuing unit, configured to issue, by the blockchain anchor, a blockchain asset on a blockchain, where an amount of the blockchain asset is not greater than the specified amount, and a transaction record of the blockchain asset in a blockchain ledger contains a freeze certificate for the off-chain asset.

According to a fourth aspect of one or more implementations of the present specification, a blockchain asset redemption apparatus is proposed, including the following: a receiving unit, configured to receive, by a blockchain anchor, a redemption request for a blockchain asset initiated by a blockchain member; an acquisition unit, configured to determine, by the blockchain anchor, whether there is a freeze certificate that corresponds to the blockchain asset based on ledger data in a blockchain ledger; and a redemption unit, configured to convert, by the blockchain anchor, the blockchain asset to an off-chain asset of a corresponding amount when there is a freeze certificate that corresponds to the blockchain asset, to provide the off-chain asset to the blockchain member.

According to a fifth aspect of one or more implementations of the present specification, an electronic device is proposed, including the following: a processor; and a memory, configured to store an instruction that can be executed by the processor, where the processor is configured to implement the method according to any one of the previous implementations.

### BRIEF DESCRIPTION OF DRAWINGS

FIG. 1 is a flowchart illustrating a blockchain asset issuing method, according to an example implementation;

FIG. 2 is a flowchart illustrating a blockchain asset redemption method, according to an example implementation;

FIG. 3 is a schematic diagram illustrating a blockchain asset issuing scenario, according to an example implementation;

FIG. 4 is a schematic diagram illustrating adding a freeze certificate to a transaction record, according to an example implementation;

FIG. 5 is a schematic diagram illustrating a blockchain asset redemption scenario, according to an example implementation;

FIG. 6 is a schematic diagram illustrating redemption of a blockchain asset by unfreezing frozen funds, according to an example implementation;

FIG. 7 is a schematic diagram illustrating redemption of a blockchain asset by using funds that are not related to frozen funds, according to an example implementation;

FIG. 8 is a schematic diagram illustrating converting a blockchain asset in place of another anchor, according to an example implementation;

FIG. 9 is a schematic structural diagram illustrating a device, according to an example implementation;

FIG. 10 is a block diagram illustrating a blockchain asset issuing apparatus, according to an example implementation;

FIG. 11 is a schematic structural diagram illustrating another device, according to an example implementation;

FIG. 12 is a block diagram illustrating a blockchain asset redemption apparatus, according to an example implementation; and

FIG. 13 is a flowchart illustrating an example of a computer-implemented method for securing a blockchain asset on a blockchain, according to an implementation of the present disclosure.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Implementations described in the following do not represent all implementations consistent with one or more implementations of the present specification. On the contrary, the implementations are only examples of apparatuses and methods that are described in the appended claims in detail and consistent with some aspects of one or more implementations of the present specification.

It is worthwhile to note that, in other implementations, steps of the corresponding method are not necessarily performed in the order shown and described in the present specification. In some other implementations, the steps included in the method can be more or less than those described in the present specification. In addition, a single step described in the present specification can be decomposed into a plurality of steps in other implementations for description, and a plurality of steps described in the present specification can be combined into a single step in other implementations for description.

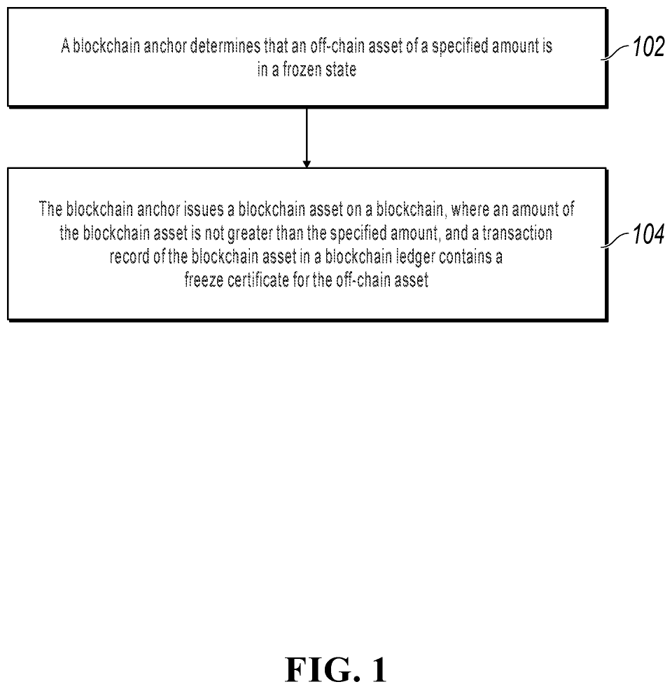

FIG. 1 is a flowchart illustrating a blockchain asset issuing method, according to an example implementation. As shown in FIG. 1, the method can include the following steps.

Step 102: A blockchain anchor determines that an off-chain asset of a specified amount is in a frozen state.

In an implementation, the role of the anchor can be played by a blockchain member, or the anchor may not be related to a blockchain member, that is, the role of the anchor is not necessarily played by a blockchain member.

In an implementation, blockchain members can be financial institutions or other forms of organizations or platforms that support an asset transfer service. Implementations are not limited in the present specification. The role of the anchor can also be played by financial institutions or other forms of organizations or platforms that support an asset transfer service. Implementations are not limited in the present specification.

In an implementation, a type of the off-chain asset can be funds or securities. The off-chain asset can be in a predetermined account, and the predetermined account is in a frozen state. As such, the off-chain asset is in a frozen state. In other words, the blockchain anchor can determine whether the predetermined account is in a frozen state by querying the operation permission to access the predetermined account.

In an implementation, the frozen state indicates that the corresponding off-chain asset cannot be used by other services and is isolated and protected from other factors. Different frozen degrees are used for different needs. For example, in a relatively strong frozen degree, bankruptcy liquidation isolation can be performed on the off-chain asset. As such, even if the anchor for freezing the off-chain asset is bankrupted, a frozen state of the off-chain asset is not affected.

In an implementation, the predetermined account can be a frozen asset-specific account specified by the blockchain anchor. That is, the account is only used to store the off-chain asset that needs to be frozen. For example, the predetermined account can be an account opened at a bank by the blockchain anchor. In other implementations, the predetermined account can be an account specified by another blockchain node or another type of account. Implementations are not limited in the present specification.

In an implementation, the type of the off-chain asset can be a real asset, and this type of off-chain asset can be at a predetermined storage location. Information collection can be performed on objects at the predetermined storage location by using an information collection device. As such, it can be determined that the off-chain asset is in a frozen state when the information collection device collects information about the off-chain asset at the predetermined storage location. For example, the information collection device can include an image collection device, and the image collection device can collect images at the predetermined storage location. As such, when it is determined that the images include the off-chain asset through image content analysis, it can be determined that the information collection device collects information about the off-chain asset at the predetermined storage location. For another example, the information collection device can include an RFID reader, and each object at the predetermined storage location has an RFID tag, and the RFID reader can read the RFID tag at the predetermined storage location. As such, when RFID tag information that corresponds to the off-chain asset is read (for example, the object ID that uniquely corresponds to the off-chain asset), it can be determined that the information collection device collects information about the off-chain asset at the predetermined storage location.

Step 104: The blockchain anchor publishes a blockchain asset on a blockchain, where an amount of the blockchain asset is not greater than the specified amount, and a transaction record of the blockchain asset in a blockchain ledger contains a freeze certificate for the off-chain asset.

In an implementation, the blockchain asset issued by the blockchain anchor on the blockchain can be of the same type as a corresponding off-chain asset. For example, when the off-chain asset is RMB, the issued blockchain asset is also RMB; when the off-chain asset is USD, the issued blockchain asset is also USD. For another example, when the off-chain asset is securities, the issued blockchain asset is also securities; when the off-chain asset is a real property, the issued blockchain asset is also a real property.

In an implementation, the blockchain asset issued by the blockchain anchor on the blockchain and a corresponding off-chain asset can be of different types. For example, the off-chain asset can be goods, and the issued blockchain asset is equivalent securities. For another example, the off-chain asset can be USD, and the issued blockchain asset is an equivalent blockchain token.

In an implementation, the blockchain anchor is configured to anchor the blockchain asset and the off-chain asset so that the off-chain asset can be converted to an equivalent blockchain asset by using the anchor, or the blockchain asset can be converted to an equivalent off-chain asset by using the anchor. As such, a one-to-one mapping is implemented between the blockchain asset and the off-chain asset. For example, the blockchain member can deposit off-chain assets at the anchor, and obtain and hold the corresponding blockchain assets issued by the anchor on the blockchain. In addition, the blockchain members can mutually transfer the blockchain assets held by the blockchain members, and a holding status of blockchain members for blockchain assets issued by anchors and a holder change status can be registered in the blockchain ledger of the blockchain to manage the blockchain assets together.

In an implementation, the freeze certificate is added to the transaction record that corresponds to the blockchain asset, so that the freeze certificate can be used to prove the reliability of the blockchain anchor, and indicate that the blockchain anchor can convert a related blockchain asset to an off-chain asset. As such, an association relationship between the blockchain asset and the off-chain asset can ensure that the blockchain asset is of a real value and is not randomly issued by the blockchain anchor.

In an implementation, the blockchain anchor can actively generate the freeze certificate after freezing the off-chain asset. For example, the blockchain anchor signs the freeze certificate generated by the blockchain anchor, and adds the freeze certificate to the transaction record.

In an implementation, the blockchain anchor can receive the freeze certificate from a trustworthy third party. That is, the freeze certificate can be signed by the trustworthy third party and then provided to the blockchain anchor. For example, the trustworthy third party can freeze the off-chain asset to generate and sign the freeze certificate. For another example, after the blockchain anchor freezes the off-chain asset and generates the freeze certificate, the trustworthy third party is used to sign the freeze certificate after confirming the frozen state, to prove that the off-chain asset is indeed in a frozen state.

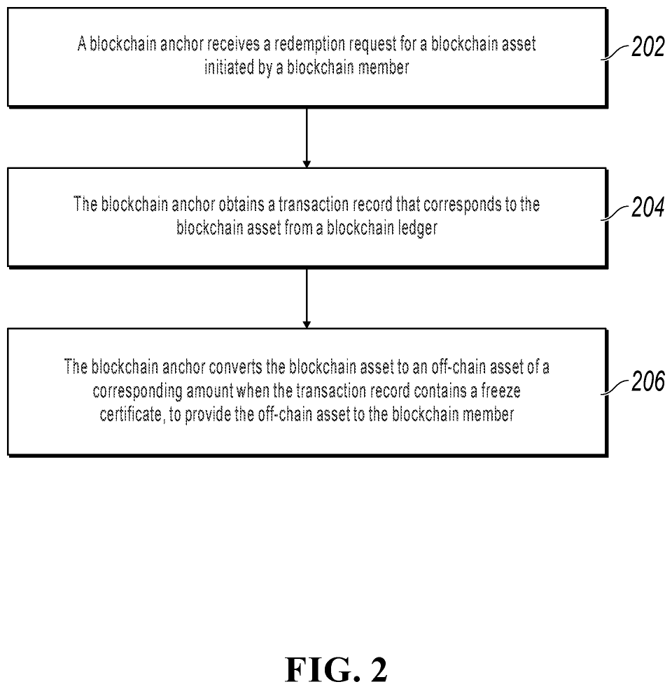

FIG. 2 is a flowchart illustrating a blockchain asset redemption method, according to an example implementation. As shown in FIG. 2, the method can include the following steps.

Step 202: A blockchain anchor receives a redemption request for a blockchain asset initiated by a blockchain member.

In an implementation, the blockchain member can specially initiate a request to convert the blockchain asset to a corresponding off-chain asset. In other implementations, the blockchain member can perform a related operation that is equivalent to initiation of a request for converting a blockchain asset, in a process of asset transfer (such as remittance), especially when the blockchain assets of the blockchain member are converted to off-chain assets.

Step 204: The blockchain anchor determines whether there is a freeze certificate that corresponds to the blockchain asset based on ledger data in a blockchain ledger.

Step 206: The blockchain anchor converts the blockchain asset to an off-chain asset of a corresponding amount when there is a freeze certificate that corresponds to the blockchain asset, to provide the off-chain asset to the blockchain member.

In an implementation, the blockchain asset can be issued by the previous blockchain anchor, and in this implementation, the blockchain asset is still converted by the blockchain anchor to the corresponding off-chain asset. The blockchain asset can be all or a part of the asset issued by the blockchain anchor, and therefore the blockchain anchor can convert the blockchain asset to all or a part of the corresponding off-chain asset based on an actual situation.

In an implementation, a transaction record that corresponds to the blockchain asset can be searched for a freeze certificate. When the transaction record contains a freeze certificate, it is determined that there is a freeze certificate that corresponds to the blockchain asset. As such, the valid value of the blockchain asset can be verified by using the off-chain asset that corresponds to the freeze certificate to reduce the possible risk caused by the redemption. In addition, there can be other methods for verifying whether there is a freeze certificate that corresponds to the blockchain asset. Implementations are not limited in the present specification. In particular, the blockchain asset can be issued by another anchor, and a freeze certificate for the blockchain asset is verified. After the verification succeeds, the blockchain asset is exchanged for a corresponding off-chain asset with the blockchain member. It is equivalent to the following case: The blockchain anchor exchanges the blockchain asset for the off-chain asset, and the blockchain anchor can further exchange the blockchain asset with other blockchain nodes or exchange the blockchain asset for a corresponding off-chain asset with the previous another anchor that publishes the blockchain asset.

In an implementation, the freeze certificate can include a signature of a trustworthy third party or an anchor that publishes the blockchain asset (for example, the blockchain anchor or the previous another anchor). For example, when the off-chain asset is frozen by the blockchain anchor, the freeze certificate can be generated and signed by the blockchain anchor, or the freeze certificate is provided to the trustworthy third party by the blockchain anchor and is signed by the trustworthy third party after the frozen state of the off-chain asset is confirmed by the trustworthy third party. For another example, when the off-chain asset is frozen by the previous another anchor, the freeze certificate can be generated and signed by the another anchor, or the freeze certificate is provided to the trustworthy third party by the another anchor and is signed by the trustworthy third party after the frozen state of the off-chain asset is confirmed by the trustworthy third party.

In an implementation, when the freeze certificate is signed by another anchor or the trustworthy third party, the blockchain anchor can initiate a query to the another anchor or the trustworthy third party to determine whether a corresponding off-chain asset is still in a frozen state. When it is confirmed that the off-chain asset is still in a frozen state, the blockchain anchor converts the corresponding blockchain asset. Otherwise, the blockchain anchor can refuse to convert the asset.

In an implementation, when off-chain assets (that is, frozen assets) that correspond to a freeze certificate are frozen by the blockchain anchor, the blockchain anchor can unfreeze the frozen assets that correspond to the freeze certificate for the exchange of blockchain assets for off-chain assets. The unfrozen assets can then be transferred to the asset storage location specified by the blockchain member. For example, when the assets are funds, the asset storage location can be an account specified by the blockchain member; for another example, when the assets are goods, the asset storage location can be a warehouse specified by the blockchain member.

In an implementation, regardless of whether frozen assets are frozen by the blockchain anchor, the blockchain anchor can exchange blockchain assets for other assets, and the other assets are different from the frozen assets that correspond to the freeze certificate.

In an implementation, the blockchain anchor can verify an issuing party of the blockchain asset and a holder of the blockchain asset. The blockchain anchor converts the blockchain asset that has a corresponding freeze certificate to the off-chain asset when the issuing party of the blockchain asset is the blockchain anchor, and the blockchain member is the holder of the blockchain asset. Otherwise (for example, the issuing party of the blockchain asset is not the blockchain anchor, or the blockchain member is not the holder of the blockchain asset), even if there is a freeze certificate for the blockchain asset, the blockchain anchor can refuse to complete the redemption.

In an implementation, after completing the redemption, the blockchain anchor can transfer the blockchain asset to a write-off specific account. There is transfer-in permission and no transfer-out permission to access the write-off specific account. As such, blockchain assets that have been converted are written off, to prevent the same blockchain asset from being converted a plurality of times.

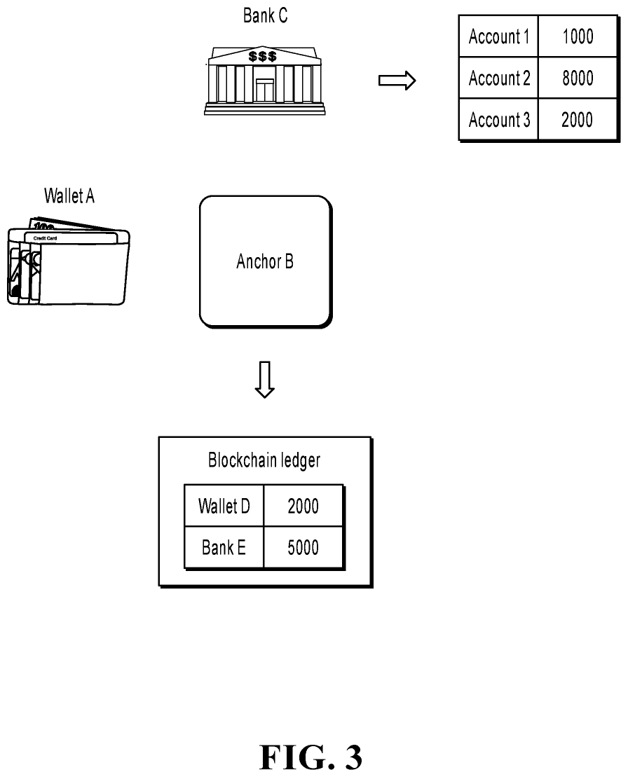

For ease of understanding, the following describes a technical solution of the present specification by using an example of issuing and converting a blockchain asset. FIG. 3 is a schematic diagram illustrating a blockchain asset issuing scenario, according to an example implementation. As shown in FIG. 3, assume that a third-party payment platform operates digital wallet A (simply referred to as wallet A), wallet A is a member on a blockchain, the blockchain further includes anchor B, and wallet A can obtain the blockchain asset issued by anchor B by using the technical solution of the present specification.

Anchor B can publish blockchain assets to wallet A, and the blockchain assets can include any type of assets such as cash, securities, stocks, or real objects (such as real properties, vehicles, and goods). Implementations are not limited in the present specification. As shown in FIG. 3, as a member on the blockchain, wallet D, bank E, etc. already hold the blockchain asset that is issued by anchor B. For example, wallet D holds a blockchain asset of 2,000 RMB that is issued by anchor B, and bank E holds a blockchain asset of 5,000 RMB that is issued by anchor B. Anchor B can register a holding status of each member for the blockchain asset issued by anchor B in the blockchain ledger that corresponds to the blockchain, and maintain the change of the holding status.

Assume that wallet A wants to obtain the blockchain asset of 1,000 RMB issued by anchor B. That is, anchor B publishes a blockchain asset to wallet A, and the blockchain asset can be funds of 1,000 RMB, or can be another asset worth 1,000 RMB. The asset can be selected or set by wallet A. For ease of description, the blockchain asset is expressed as funds of 1,000 RMB in the following.

Anchor B can publish the blockchain asset of 1,000 RMB to wallet A in the following steps.

Step 1: Wallet A transfers 1,000 RMB to anchor B.

In an implementation, wallet A and anchor B separately open an account at bank C. For example, as shown in FIG. 3, account 1 belongs to wallet A, and account 2 and account 3 belong to anchor B. Therefore, wallet A can trigger account 1 to transfer 1,000 RMB to account 2 or account 3.

In an implementation, anchor B can agree in advance that objects that want to publish blockchain assets at anchor B transfer corresponding off-chain funds to a specified account. For example, the account can be account 2 of bank C or another specified account. Therefore, wallet A can transfer 1,000 RMB from account 1 to account 2. Certainly, wallet A can also transfer 1,000 RMB from account 1 to account 3 and notifies anchor B by using a predetermined path, so that anchor B transfers funds of 1,000 RMB from account 3 to account 2.

In an implementation, during transfer, wallet A can indicate in the transfer remark the member ID and the deposit instruction of wallet A on the blockchain. After receiving the transfer remark, anchor B can determine that wallet A needs to publish the transferred 1,000 RMB as blockchain funds by parsing out the member ID and the deposit instruction.

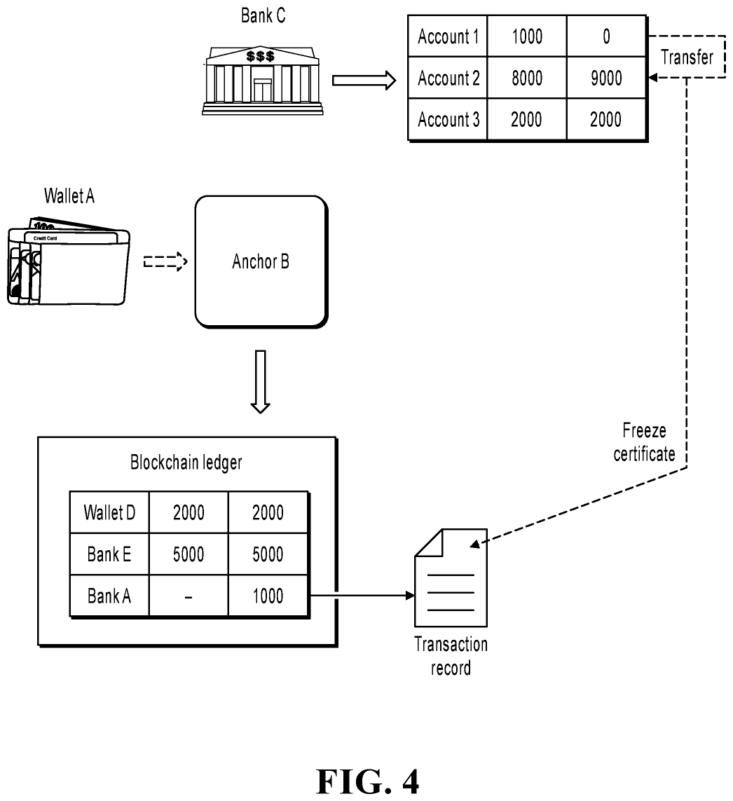

In an implementation, assume that the initial funds of account 1 are 1,000 RMB, the initial funds of account 2 are 8,000 RMB, and the initial funds of account 3 are 2,000 RMB. After wallet A transfers 1,000 RMB to anchor B, the remaining funds of account 1 are 0 RMB, the remaining funds of account 2 are 9,000 RMB, and the remaining funds of account 3 are 2,000 RMB, as shown in FIG. 4.

Step 2: Anchor B freezes the funds transferred by wallet A, and generates a freeze certificate.

In an implementation, account 2 can be a frozen funds-specific account set for anchor B, so that 1,000 RMB provided by wallet A is frozen in account 2. Similarly, funds transferred by other objects for issuing blockchain assets can also be frozen in account 2 to manage funds with similar uses together. Certainly, anchor B does not necessarily need to set a frozen funds-specific account, and can freeze all or a part of funds in a common account. Implementations are not limited in the present specification.

In an implementation, anchor B can freeze account 2, or freeze funds of 1,000 RMB in account 2. Implementations are not limited in the present specification. In addition, anchor B can generate a freeze certificate for the freeze operation, and sign the freeze certificate.

In an implementation, to increase the trustworthiness of the freeze certificate, anchor B can cooperate with a trustworthy third party (such as an authorized institution or a supervision department), and the trustworthy third party signs the freeze certificate after the trustworthy third party confirms that anchor B performs the freeze operation.

Step 3: Anchor B publishes an asset on a blockchain, and adds the freeze certificate to a transaction record that corresponds to the asset in a blockchain ledger.

In an implementation, an asset issuing operation performed by anchor B on the blockchain can form a corresponding transaction record in the blockchain ledger to prove that the asset is real and valid.

In an implementation, the freeze certificate is added to the transaction record that corresponds to the asset. As such, after obtaining the asset, a blockchain node can query a corresponding transaction record in the blockchain ledger to obtain a freeze certificate contained in the transaction record, so as to determine that the asset has a corresponding off-chain asset as a guarantee and prove that the asset indeed has a corresponding value and is not randomly issued.

Step 4: Anchor B records the issued blockchain asset as a blockchain balance held by wallet A.

In an implementation, assume that only wallet D and bank E initially hold the blockchain assets issued by anchor B. For example, as shown in FIG. 3, wallet D holds 2,000 RMB and bank E holds 5,000 RMB. If wallet A holds the previously issued blockchain assets, in addition to wallet D and bank E, wallet A also holds 1,000 RMB issued by anchor B, as shown in FIG. 4.

For example, wallet A holds funds of 1,000 RMB issued by anchor B. It is worthwhile to note that “1000” shown in FIG. 4 is only a number in the blockchain ledger, and is created and registered by anchor B for wallet A. Only when anchor B can convert the number “1000” to the off-chain asset of 1,000 RMB, the number “1000” can really represent “1,000 RMB”. Therefore, the freeze certificate is added in step 3 for proving that anchor B can convert the number “1000” to the off-chain asset of 1,000 RMB. As such, it indicates that the number “1000” can indeed represent “1,000 RMB”.

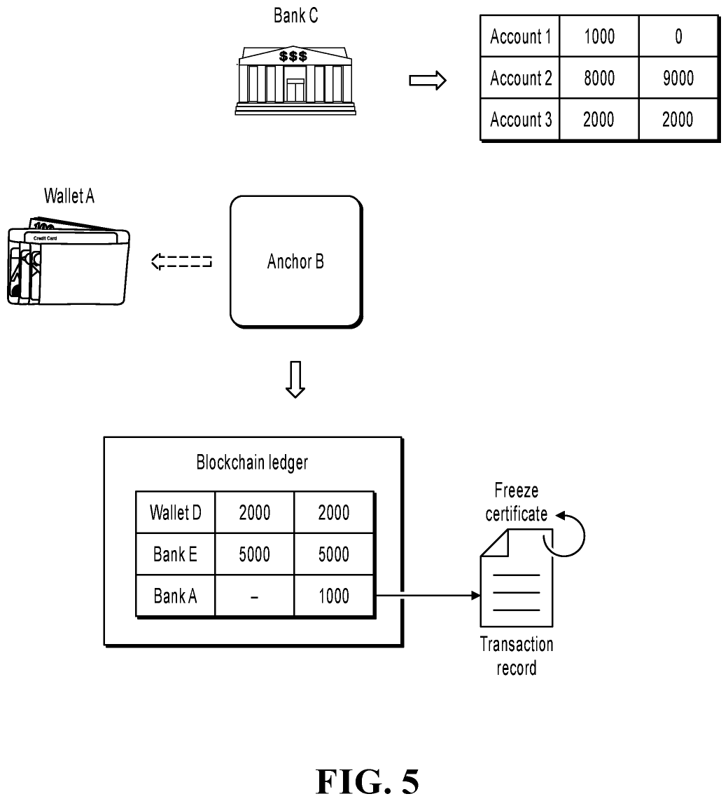

FIG. 5 is a schematic diagram illustrating a blockchain asset redemption scenario, according to an example implementation. As shown in FIG. 5, assume that wallet A holds the blockchain asset of 1,000 RMB issued by anchor B, and the asset can be converted to off-chain 1,000 RMB in the following method.

Step 1: Wallet A initiates a redemption request to anchor B by using a bridge module between wallet A and a blockchain.

In an implementation, wallet A can indicate the blockchain assets that are expected to be redeemed in the redemption request. As such, anchor B converts the blockchain assets to the off-chain assets and provides the off-chain assets to wallet A. For example, when a blockchain asset that needs to be converted is a blockchain asset issued by anchor B, wallet A can indicate the amount of funds to be obtained through redemption in the redemption request. For example, wallet A can mark the amount of funds as 1,000 RMB.

Step 2: Anchor B can determine a transaction record that corresponds to a blockchain asset to be converted, and check whether the transaction record contains a freeze certificate.

In an implementation, when wallet A needs to perform a transfer to bank E, for example, when wallet A needs to pay bank E with a blockchain asset of 500 RMB issued by anchor B, the blockchain balance held by wallet A and issued by anchor B can be decreased by 500 RMB, and the blockchain balance held by bank E and issued by anchor B can be increased by 500 RMB. When wallet A needs to perform a transfer to wallet Q that is not shown in the figure, for example, when wallet A needs to pay wallet Q with a blockchain asset of 500 RMB issued by anchor B, an intermediate member between wallet A and wallet Q needs to be found. For example, assume that bank E separately holds blockchain balances that are issued by anchor B and anchor P that is not shown in the figure. The blockchain balance held by wallet A and issued by anchor B can be decreased by 500 RMB, and the blockchain balance held by bank E and issued by anchor B can be increased by 500 RMB. In addition, the blockchain balance held by bank E and issued by anchor P can be decreased by 500 RMB, and the blockchain balance held by wallet Q and issued by anchor P can be increased by 500 RMB. As such, wallet A pays 500 RMB to wallet Q.

In an implementation, anchor B can convert the blockchain assets issued by other anchors in place of the anchors, provided that anchor B determines that the blockchain assets are valid and determines that the anchors that publish the blockchain assets have sufficient redemption capability by using a freeze certificate.

Step 3: Anchor B decreases a blockchain asset held by wallet A and issued by anchor B by 1,000 RMB, and transfers 1,000 RMB from account 2 or account 3 of anchor B at bank C to account 1 of wallet A.

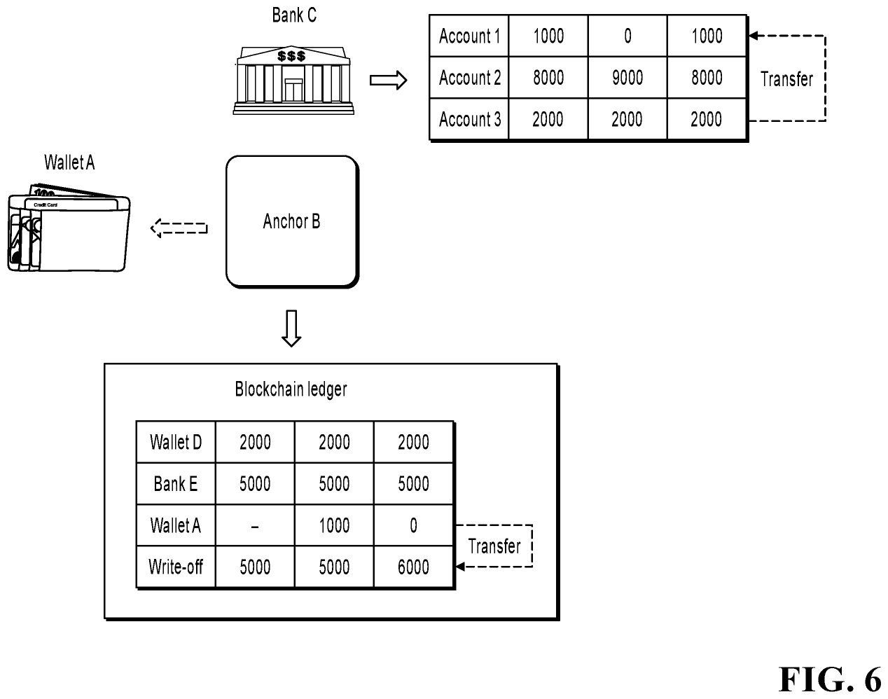

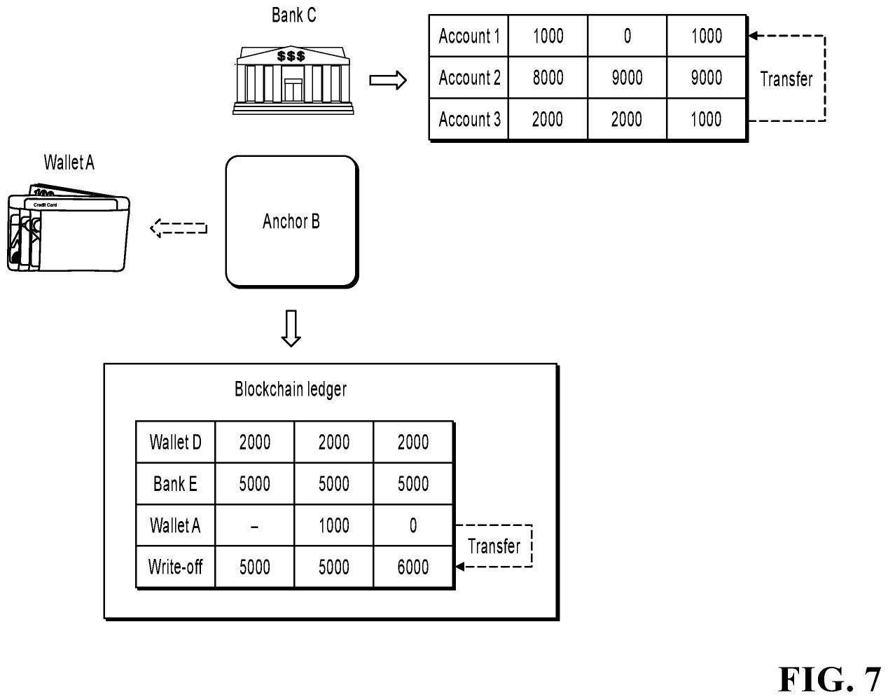

In an implementation, anchor B can maintain a blockchain asset write-off account shown in FIG. 6 and FIG. 7. For example, the blockchain asset write-off account initially holds the blockchain asset of 5,000 RMB issued by anchor B, and then the blockchain asset of 1,000 RMB issued by anchor B and held by wallet A is transferred to the blockchain asset write-off account so as to write off the blockchain asset of 1,000 RMB issued by anchor B. The feature of the blockchain asset write-off account is as follows: A blockchain asset can be transferred to the account and cannot be transferred from the account. Therefore, a transfer of the blockchain asset to the blockchain asset write-off account is equivalent to destruction, and the blockchain asset transferred in cannot be stolen and repeatedly issued.

In an implementation, as shown in FIG. 6, anchor B can unfreeze 1,000 RMB previously frozen in account 2, and transfer unfrozen 1,000 RMB to account 1. As such, the transfer is completed. In other implementations, as shown in FIG. 7, anchor B can transfer 1,000 RMB from account 3 that is not related to the frozen funds to account 1. As such, the transfer is also completed. Implementations are not limited in the present specification. Actually, in addition to bank C, if anchor B and wallet A have accounts at other banks, anchor B and wallet A can also complete a transfer by using the banks. Implementations are not limited in the present specification.

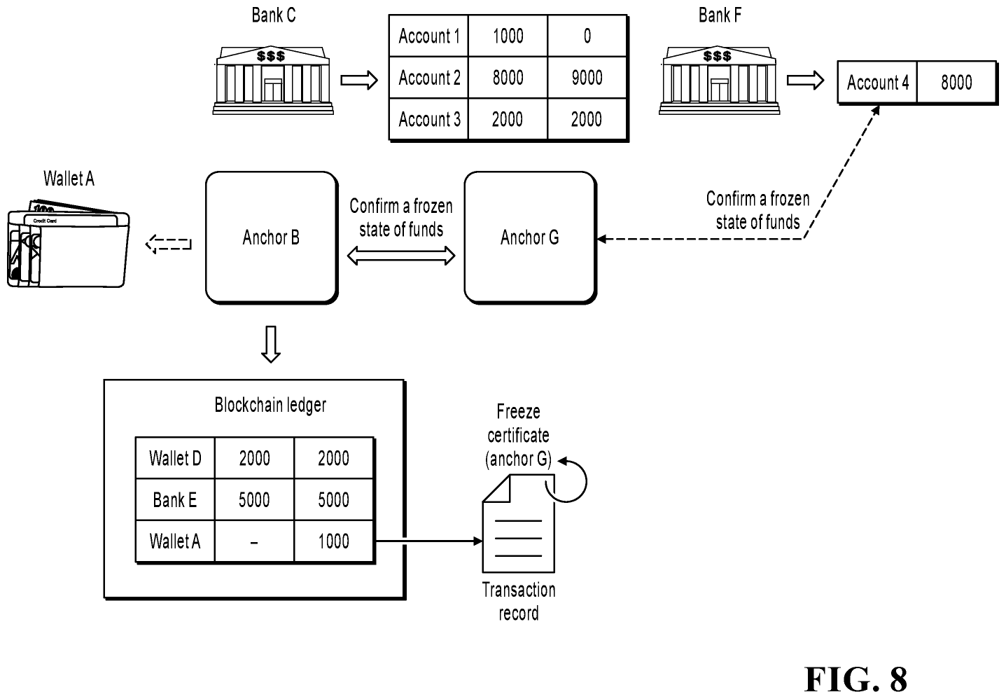

FIG. 8 is a schematic diagram illustrating redeeming a blockchain asset in place of another anchor, according to an example implementation. As shown in FIG. 8, assume that wallet A holds a blockchain asset of 1,000 RMB, and the blockchain asset is issued by anchor G. However, for some reasons, wallet A wants to redeem the blockchain asset at anchor B. Anchor B can determine that the blockchain asset is issued by anchor G by using a transaction record of the blockchain asset in a blockchain ledger. If the transaction record contains a freeze certificate signed by anchor G or a trustworthy third party, it indicates that anchor G freezes an off-chain asset of an equivalent amount or a larger amount when issuing the blockchain asset, and anchor B can determine that the blockchain asset is real and valid. Certainly, anchor B can also temporarily initiate a query to anchor G, to determine whether the related off-chain asset is still in a frozen state and is enough for redeeming the blockchain asset. When anchor G returns confirmation information of the frozen state to anchor B, anchor B can determine that the related off-chain asset is still in a frozen state and is enough for redeeming the blockchain asset.

Therefore, anchor B can reserve the related blockchain asset, and can transfer the blockchain asset from wallet A to the blockchain account of anchor B and transfer 1,000 RMB from account 2 or account 3 to account 1 that corresponds to wallet A. Afterwards, anchor B can transfer the blockchain asset to anchor G, and anchor G transfers the off-chain asset of 1,000 RMB to an off-chain account of anchor B to complete the redemption.

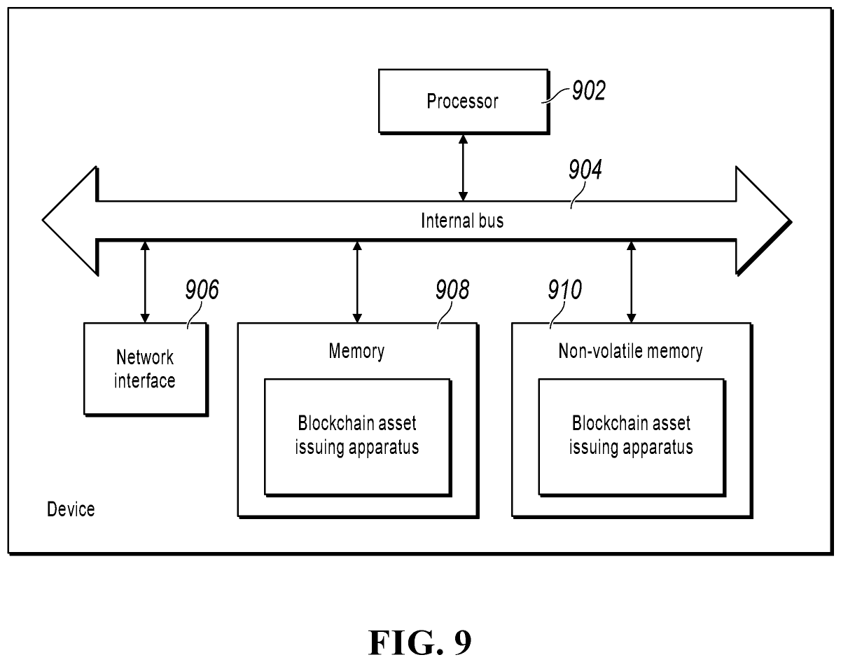

FIG. 9 is a schematic structural diagram illustrating a device, according to an example implementation. Referring to FIG. 9, in terms of hardware, the device includes a processor 902, an internal bus 904, a network interface 906, a memory 908, and a non-volatile memory 910, and certainly can further include hardware needed by other services. The processor 902 reads a corresponding computer program from the non-volatile memory 910 into the memory 908 and then runs the corresponding computer program, so as to form the blockchain asset issuing apparatus in terms of logic. Certainly, in addition to a software implementation, one or more implementations of the present specification do not exclude another implementation, for example, a logical device or a combination of hardware and software. That is, an execution body of the following processing procedure is not limited to each logical unit, and can also be hardware or a logical device.

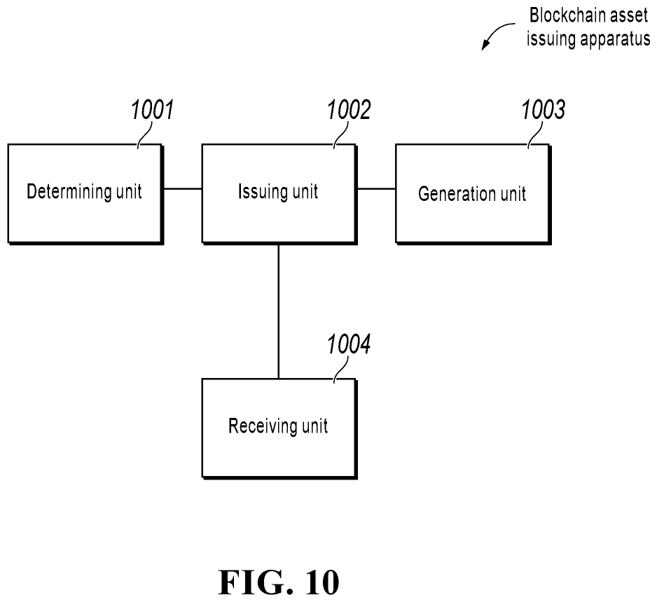

Referring to FIG. 10, in a software implementation, the blockchain asset issuing apparatus can include the following: a determining unit 1001, configured to determine, by a blockchain anchor, that an off-chain asset of a specified amount is in a frozen state; and an issuing unit 1002, configured to issue, by the blockchain anchor, a blockchain asset on a blockchain, where an amount of the blockchain asset is not greater than the specified amount, and a transaction record of the blockchain asset in a blockchain ledger contains a freeze certificate for the off-chain asset.

Optionally, a type of the off-chain asset is funds or securities, and the off-chain asset is in a predetermined account, and the predetermined account is in a frozen state.

Optionally, the predetermined account is a frozen asset-specific account specified by the blockchain anchor.

Optionally, a type of the off-chain asset is a real asset, the off-chain asset is at a predetermined storage location, and it is determined that the off-chain asset is in a frozen state when an information collection device collects information about the off-chain asset at the predetermined storage location.

Optionally, the apparatus further includes a generation unit 1003 or a receiving unit 1004.

The generation unit 1003 is configured to generate, by the blockchain anchor, the freeze certificate after the blockchain anchor freezes the off-chain asset.

The receiving unit 1004 is configured to receive, by the blockchain anchor, the freeze certificate from a trustworthy third party, where the trustworthy third party freezes the off-chain asset.

Optionally, the blockchain asset is of the same type as a corresponding off-chain asset.

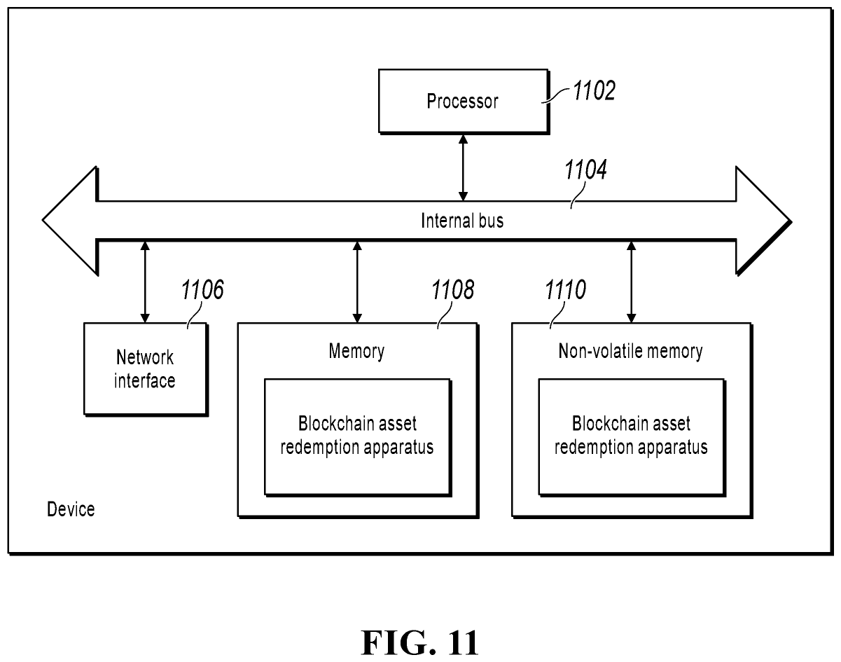

FIG. 11 is a schematic structural diagram illustrating a device, according to an example implementation. Referring to FIG. 11, in terms of hardware, the device includes a processor 1102, an internal bus 1104, a network interface 1106, a memory 1108, and a non-volatile memory 1110, and certainly can further include hardware needed by other services. The processor 1102 reads a corresponding computer program from the non-volatile memory 1110 into the memory 1108 and then runs the corresponding computer program, so as to form the blockchain asset redemption apparatus in terms of logic. Certainly, in addition to a software implementation, one or more implementations of the present specification do not exclude another implementation, for example, a logical device or a combination of hardware and software. That is, an execution body of the following processing procedure is not limited to each logical unit, and can also be hardware or a logical device.

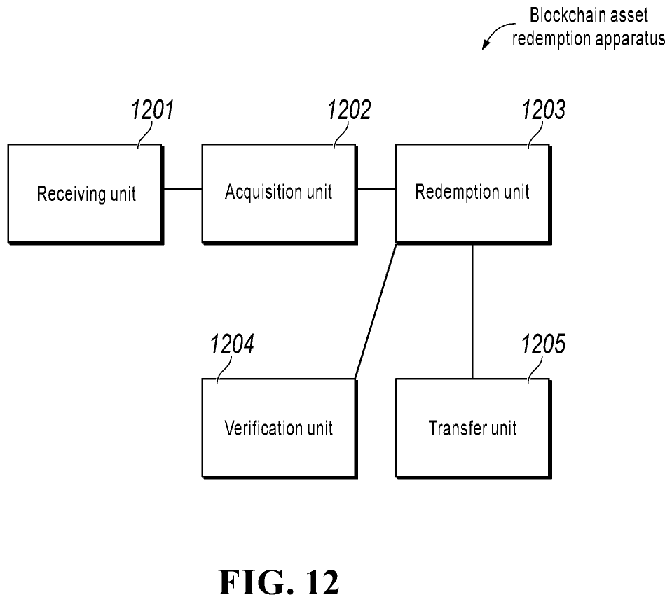

Referring to FIG. 12, in a software implementation, the blockchain asset redemption apparatus can include the following: a receiving unit 1201, configured to receive, by a blockchain anchor, a redemption request for a blockchain asset initiated by a blockchain member; an acquisition unit 1202, configured to determine, by the blockchain anchor, whether there is a freeze certificate that corresponds to the blockchain asset based on ledger data in a blockchain ledger; and a redemption unit 1203, configured to convert, by the blockchain anchor, the blockchain asset to an off-chain asset of a corresponding amount when there is a freeze certificate that corresponds to the blockchain asset, to provide the off-chain asset to the blockchain member.

Optionally, the freeze certificate includes a signature of a trustworthy third party or an anchor that issues the blockchain asset.

Optionally, the redemption unit 1203 is configured to unfreeze, by the blockchain anchor, a frozen asset that corresponds to the freeze certificate to use the asset as the off-chain asset and transfer the off-chain asset to an asset storage location specified by the blockchain member; or use, by the blockchain anchor, another asset as the off-chain asset, where the another asset is different from a frozen asset that corresponds to the freeze certificate.

Optionally, the apparatus further includes the following: a verification unit 1204, configured to verify, by the blockchain anchor, an issuing party of the blockchain asset and a holder of the blockchain asset.

The redemption unit 1203 is configured to redeem, by the blockchain anchor, the blockchain asset that has a corresponding freeze certificate to the off-chain asset when the issuing party of the blockchain asset is the blockchain anchor, and the blockchain member is the holder of the blockchain asset.

Optionally, the apparatus further includes the following: a transfer unit 1205, configured to transfer, by the blockchain anchor, the blockchain asset to a write-off specific account after completing the redemption.

There is transfer-in permission and no transfer-out permission to access the write-off specific account.

The system, apparatus, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, an intelligent phone, a personal digital assistant, a media player, a navigation device, an email receiving and sending device, a game console, a tablet computer, a wearable device, or any combination of these devices.

In a typical configuration, a computer includes one or more processors (CPU), one or more input/output interfaces, one or more network interfaces, and one or more memories.

The memory can include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. A computer storage medium includes but is not limited to a parameter random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a magnetic tape, a magnetic disk storage, a quantum memory, a graphene storage medium, another magnetic storage device, or any other non-transmission medium. The computer storage medium can be used to store information that can be accessed by a computing device. Based on the definition in the present specification, the computer readable medium does not include transitory computer readable media (transitory media) such as a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such a process, method, product or device. Without more constraints, an element preceded by “includes a . . . ” does not preclude the existence of additional identical elements in the process, method, product or device that includes the element.

Specific implementations of the present specification are described above. Other implementations fall within the scope of the appended claims. In some situations, the actions or steps described in the claims can be performed in an order different from the order in the implementations and the desired results can still be achieved. In addition, the process depicted in the accompanying drawings does not necessarily require a particular execution order to achieve the desired results. In some implementations, multi-tasking and parallel processing can be advantageous.

The terms used in the one or more implementations of the present specification are merely for illustrating specific implementations, and are not intended to limit the one or more of implementations of the present specification. The terms “a” and “the” of singular forms used in the one or more implementations of the present specification and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. can be used in the one or more implementations of the present specification to describe various types of information, the information is not limited to the terms. These terms are only used to differentiate information of the same type. For example, without departing from the scope of the one or more implementations of the present specification, first information can also be referred to as second information, and similarly, the second information can be referred to as the first information. Depending on the context, for example, the word “if” used here can be explained as “while”, “when”, or “in response to determining”.

The previous descriptions are only example implementations of the one or more implementations of the present specification, but are not intended to limit one or more implementations of the present specification. Any modification, equivalent replacement, improvement, etc. made without departing from the spirit and principle of the one or more implementations of the present specification shall fall within the protection scope of the one or more implementations of the present specification.

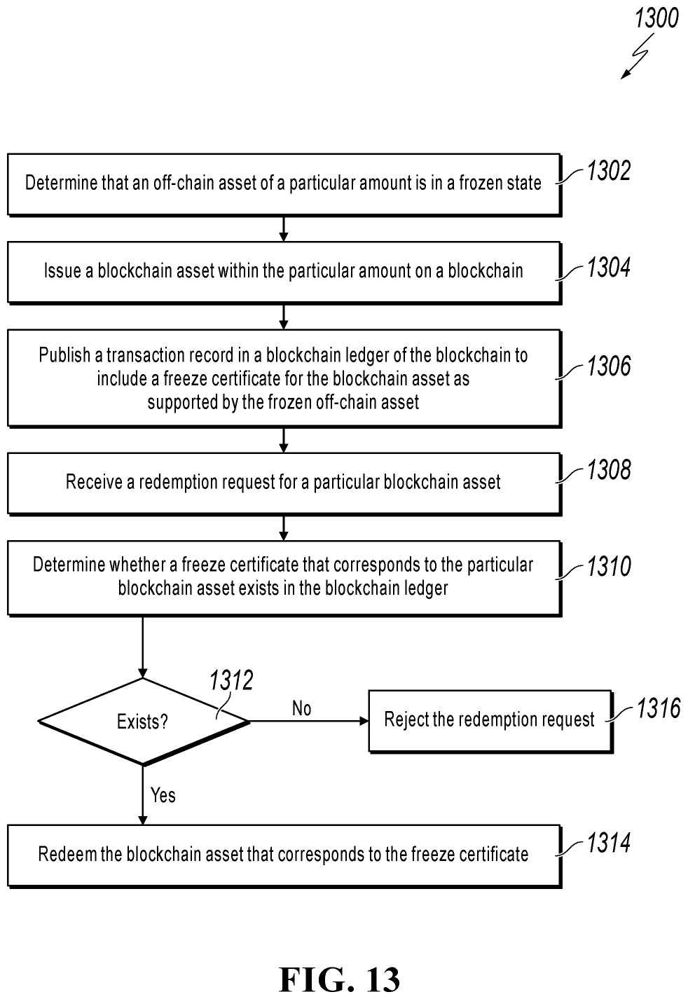

In the above context, FIG. 13 is a flowchart illustrating an example of a computer-implemented method 1300 for supporting a blockchain asset issued on a blockchain, according to an implementation of the present disclosure. For clarity of presentation, the description that follows generally describes method 1300 in the context of the other figures in this description. However, it will be understood that method 1300 can be performed, for example, by any system, environment, software, and hardware, or a combination of systems, environments, software, and hardware, as appropriate. In some implementations, various steps of method 1300 can be run in parallel, in combination, in loops, or in any order.

At 1302, a blockchain anchor determines that an off-chain asset of a particular amount is in a frozen state. As described above in association with FIGS. 1-8, the blockchain anchor can be a blockchain member, a financial institution, or other forms of organizations or platforms that support an asset transfer service. The off-chain asset can be funds, securities, or a real asset (which can have a radio-frequency identification tag). In some implementations, the off-chain asset can be in a predetermined account with special access permissions. As such, the blockchain anchor can determine whether the predetermined account is in a frozen state by querying the operation permission to access the predetermined account. In case of a real asset, the off-chain asset can be at a predetermined storage location. Information collection can be performed on objects at the predetermined storage location by using an information collection device. As such, the off-chain asset can be in a frozen state when the information collection device collects information about the off-chain asset at the predetermined storage location. An off-chain asset is in a frozen state when the off-chain asset cannot be used by other services on the blockchain and hence becomes isolated. For example, the frozen off-chain asset is isolated and protected from blockchain asset in circulation on the blockchain. From 1302, method 1300 proceeds to 1304.

At 1304, the blockchain anchor issues a blockchain asset on a blockchain. The blockchain asset may be valued within the particular amount of the off-chain asset that is in the frozen state. The issuance of the blockchain asset allows circulation of the blockchain asset on the blockchain for consumption by blockchain members. From 1304, method 1300 proceeds to 1306.

At 1306, the blockchain anchor publishes a transaction record in a blockchain ledger on the blockchain. The transaction record include a freeze certificate showing that the issued blockchain asset is supported by the off-chain asset in the frozen state. In one example, the blockchain asset issued by the blockchain anchor on the blockchain can be of the same type as a corresponding off-chain asset. In another example, the blockchain asset issued by the blockchain anchor on the blockchain and a corresponding off-chain asset can be of different types. Here, the freeze certificate may be added to the transaction record that corresponds to the blockchain asset, so that the freeze certificate can be used to prove the reliability of the blockchain anchor, and indicate that the blockchain anchor can convert a related blockchain asset to an off-chain asset. As such, an association relationship between the blockchain asset and the off-chain asset can support that the blockchain asset is of a real value and is not randomly issued by the blockchain anchor. From 1306, method 1300 proceeds to 1308.

At 1308, the blockchain anchor receives a redemption request from a blockchain member for a particular blockchain asset. The redemption request may pertain to the submitting blockchain member's desire to convert the particular blockchain asset into an off-chain asset. For example, the submitting blockchain member may wish to redeem the particular blockchain asset from the form of tokens to, for example, USD. From 1308, method 1300 proceeds to 1310.

At 1310, a determination is made as to whether a freeze certificate that corresponds to the particular blockchain asset exists in the blockchain ledger. In response to determining that the freeze certificate that corresponds to the particular blockchain asset exists (1312) in the blockchain ledger, method 1300 proceeds to 1314 to convert the particular blockchain asset to an off-chain asset of a corresponding amount. Otherwise, in response to determining that the freeze certificate that corresponds to the particular blockchain asset does not exist in the blockchain ledger, method 1300 proceeds to 1316 to reject the redemption request.

The blockchain implementations described in the present specification can dedicate an off-chain asset to support the circulation of a blockchain asset issued by a blockchain anchor on the blockchain. Through technical implementations on the blockchain, a freeze certificate is issued to link the issued blockchain asset with the dedicated off-chain asset. Once frozen, the off-chain asset may be isolated from circulation on the blockchain. The frozen off-chain asset may be maintained at a predetermined account for the purpose of redemption based on a corresponding freeze certificate when a blockchain member holding a particular blockchain asset in circulation requests a redemption of the particular blockchain asset. The freeze certificate thus serves to support the particular blockchain asset in that the off-chain asset and can attest to the real value of the particular blockchain asset. The freeze certificate is generated and signed by a blockchain anchor (or generated and signed by a trusted third party, such as a financial institution, and then received and signed by the blockchain anchor). The digital signature and chaining implementations render the freeze certificate tamper-proof and transparent for all members on the blockchain.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method for supporting a blockchain asset issued on a blockchain, the computer-implemented method comprising:
determining, by a blockchain anchor, that an off-chain asset of a particular amount is in a frozen state; and
issuing, by the blockchain anchor, the blockchain asset on the blockchain, wherein an amount of the blockchain asset is within the particular amount; and
publishing, by the blockchain anchor, a transaction record of the blockchain asset in a blockchain ledger of the blockchain, the transaction record including a freeze certificate for the blockchain asset showing that the blockchain asset is supported by the off-chain asset that has been determined to be in the frozen state.

2. The computer-implemented method of claim 1, further comprising:
receiving, by a blockchain anchor, a redemption request for a particular blockchain asset initiated by a blockchain member on the blockchain;
determining, by the blockchain anchor, whether a freeze certificate that corresponds to the particular blockchain asset exists in the blockchain ledger; and
in response to determining that the freeze certificate that corresponds to the particular blockchain asset exists in the blockchain ledger, redeeming, by the blockchain anchor, the particular blockchain asset by converting the particular blockchain asset to an off-chain asset of a corresponding amount.

3. The computer-implemented method of claim 2, wherein converting, by the blockchain anchor, the particular blockchain asset to the off-chain asset of the corresponding amount comprises:
unfreezing, by the blockchain anchor, the off-chain asset that corresponds to the freeze certificate and that is in the frozen state, wherein the off-chain asset comprises a fund or a security in a predetermined account specified by the blockchain anchor.

4. The computer-implemented method of claim 2, further comprising:
verifying, by the blockchain anchor, an issuing party of the particular blockchain asset and a holder of the particular blockchain asset; and
redeeming, by the blockchain anchor, the particular blockchain asset that has a corresponding freeze certificate, wherein the issuing party of the particular blockchain asset is the blockchain anchor, and wherein the blockchain member is the holder of the particular blockchain asset.

5. The computer-implemented method of claim 4, further comprising: (i) generating, by the blockchain anchor, the freeze certificate after freezing the off-chain asset, wherein the freeze certificate comprises a digital signature of the blockchain anchor that issues the particular blockchain asset; or
(ii) receiving, by the blockchain anchor, the freeze certificate from a trustworthy third party, wherein the freeze certificate comprises a digital signature of a trustworthy third party and a digital signature of the blockchain anchor that issues the particular blockchain asset.

6. The computer-implemented method of claim 2, further comprising:
in response to redeeming the particular blockchain asset, transferring, by the blockchain anchor, the particular blockchain asset to a write-off specific account , wherein the write-off specific account comprises a transfer-in permission and no transfer-out permission to access the write-off specific account, and wherein the particular blockchain asset is of the same type as the off-chain asset.

7. The computer-implemented method of claim 1, wherein a type of the off-chain asset is a real asset, wherein the off-chain asset is at a predetermined storage location, wherein an information collection device collects information about the off-chain asset at the predetermined storage location, and wherein the information collection device comprises a radio frequency identifier tag reader, and wherein the off-chain asset comprises a radio frequency identifier tag.

8. A non-transitory, computer-readable medium storing one or more instructions executable by a computer system to perform operations comprising:
determining, by a blockchain anchor, that an off-chain asset of a particular amount is in a frozen state; and
issuing, by the blockchain anchor, a blockchain asset on the blockchain, wherein an amount of the blockchain asset is within the particular amount; and
publishing, by the blockchain anchor, a transaction record of the blockchain asset in a blockchain ledger of the blockchain, the transaction record including a freeze certificate for the blockchain asset showing that the blockchain asset is supported by the off-chain asset that has been determined to be in the frozen state.

9. The non-transitory, computer-readable medium of claim 8, wherein the operations further comprise:
receiving, by a blockchain anchor, a redemption request for a particular blockchain asset initiated by a blockchain member on the blockchain;
determining, by the blockchain anchor, whether a freeze certificate that corresponds to the particular blockchain asset exists in the blockchain ledger; and
in response to determining that the freeze certificate that corresponds to the particular blockchain asset exists in the blockchain ledger, redeeming, by the blockchain anchor, the particular blockchain asset by converting the particular blockchain asset to an off-chain asset of a corresponding amount.

10. The non-transitory, computer-readable medium of claim 9, wherein converting, by the blockchain anchor, the particular blockchain asset to the off-chain asset of the corresponding amount comprises:
unfreezing, by the blockchain anchor, the off-chain asset that corresponds to the freeze certificate and that is in the frozen state, wherein the off-chain asset comprises a fund or a security in a predetermined account specified by the blockchain anchor.

11. The non-transitory, computer-readable medium of claim 9, wherein the operations further comprise:
verifying, by the blockchain anchor, an issuing party of the particular blockchain asset and a holder of the particular blockchain asset; and
redeeming, by the blockchain anchor, the particular blockchain asset that has a corresponding freeze certificate, wherein the issuing party of the particular blockchain asset is the blockchain anchor, and wherein the blockchain member is the holder of the particular blockchain asset.

12. The non-transitory, computer-readable medium of claim 11, further comprising:
(i) generating, by the blockchain anchor, the freeze certificate after freezing the off-chain asset, wherein the freeze certificate comprises a digital signature of the blockchain anchor that issues the particular blockchain asset; or
(ii) receiving, by the blockchain anchor, the freeze certificate from a trustworthy third party, wherein the freeze certificate comprises a digital signature of a trustworthy third party and a digital signature of the blockchain anchor that issues the particular blockchain asset.

13. The non-transitory, computer-readable medium of claim 9, wherein the operations further comprise:
in response to redeeming the particular blockchain asset, transferring, by the blockchain anchor, the particular blockchain asset to a write-off specific account , wherein the write-off specific account comprises a transfer-in permission and no transfer-out permission to access the write-off specific account, and wherein the particular blockchain asset is of the same type as the off-chain asset.

14. The non-transitory, computer-readable medium of claim 8, wherein a type of the off-chain asset is a real asset, wherein the off-chain asset is at a predetermined storage location, wherein an information collection device collects information about the off-chain asset at the predetermined storage location, and wherein the information collection device comprises a radio frequency identifier tag reader, and wherein the off-chain asset comprises a radio frequency identifier tag.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining, by a blockchain anchor, that an off-chain asset of a particular amount is in a frozen state; and
issuing, by the blockchain anchor, a blockchain asset on the blockchain, wherein an amount of the blockchain asset is within the particular amount; and
publishing, by the blockchain anchor, a transaction record of the blockchain asset in a blockchain ledger of the blockchain, the transaction record including a freeze certificate for the blockchain asset showing that the blockchain asset is supported by the off-chain asset that has been determined to be in the frozen state.

16. The computer-implemented system of claim 15, wherein the operations further comprise:
receiving, by a blockchain anchor, a redemption request for a particular blockchain asset initiated by a blockchain member on the blockchain;
determining, by the blockchain anchor, whether a freeze certificate that corresponds to the particular blockchain asset exists in the blockchain ledger; and
in response to determining that the freeze certificate that corresponds to the particular blockchain asset exists in the blockchain ledger, redeeming, by the blockchain anchor, the particular blockchain asset by converting the particular blockchain asset to an off-chain asset of a corresponding amount.

17. The computer-implemented system of claim 16, wherein converting, by the blockchain anchor, the particular blockchain asset to the off-chain asset of the corresponding amount comprises:
unfreezing, by the blockchain anchor, the off-chain asset that corresponds to the freeze certificate and that is in the frozen state, wherein the off-chain asset comprises a fund or a security in a predetermined account specified by the blockchain anchor.

18. The computer-implemented system of claim 16, wherein the operations further comprise:
verifying, by the blockchain anchor, an issuing party of the particular blockchain asset and a holder of the particular blockchain asset; and
redeeming, by the blockchain anchor, the particular blockchain asset that has a corresponding freeze certificate, wherein the issuing party of the particular blockchain asset is the blockchain anchor, and wherein the blockchain member is the holder of the particular blockchain asset.

19. The computer-implemented system of claim 18, further comprising:
(i) generating, by the blockchain anchor, the freeze certificate after freezing the off-chain asset, wherein the freeze certificate comprises a digital signature of the blockchain anchor that issues the particular blockchain asset; or
(ii) receiving, by the blockchain anchor, the freeze certificate from a trustworthy third party, wherein the freeze certificate comprises a digital signature of a trustworthy third party and a digital signature of the blockchain anchor that issues the particular blockchain asset.

20. The computer-implemented system of claim 16, wherein the operations further comprise:
in response to redeeming the blockchain asset, transferring, by the blockchain anchor, the particular blockchain asset to a write-off specific account , wherein the write-off specific account comprises a transfer-in permission and no transfer-out permission to access the write-off specific account, and wherein the particular blockchain asset is of the same type as the off-chain asset.

21. The computer-implemented system of claim 15, wherein a type of the off-chain asset is a real asset, wherein the off-chain asset is at a predetermined storage location, wherein an information collection device collects information about the off-chain asset at the predetermined storage location, and, wherein the information collection device comprises a radio frequency identifier tag reader, and wherein the off-chain asset comprises a radio frequency identifier tag.
